(19) United States
(12) Patent Application Publication
(10) Pub. No.: US 2015/0065923 A1
(43) Pub. Date: Mar. 5, 2015

(54) APPARATUS FOR HEAT STRAIN REDUCTION

(71) Applicant: Harcor Security Seals Pty Limited, Frenchs Forest (AU)

(72) Inventor: Peter Schaede, Frenchs Forest (AU)

(73) Assignee: Harcor Security Seals Pty Limited, Frenchs Forest (AU)

(21) Appl. No.: 14/043,112

(22) Filed: Oct. 1, 2013

(30) Foreign Application Priority Data
Aug. 29, 2013 (AU) 2013903289

(51) Int. Cl. A61H 33/00

(52) U.S. Cl. CPC A61H 33/00; A61H 2201/0214
USPC 601/17

(57) ABSTRACT

The present invention relates to an apparatus for reducing heat strain. The apparatus includes a pair of receptacles each of which being attached to a web. Each receptacle is adapted to carry a coolant. The web is adapted to engage and be suspended from a foreign object such as a human being or a chair to support the receptacle.

### TECHNICAL FIELD

This invention broadly relates to an apparatus equipped with receptacles for enabling a user to cool off his or her extremities in order to reduce heat strain.

### BACKGROUND OF THE INVENTION

It is well recognised that rehabilitation of fire fighters is a pressing issue which is constantly addressed by agencies and authorities from around the world. Studies have revealed that the maximum time period of strenuous work a fire fighter can sustain is approximately 45 minutes. The fire fighter's body temperature will get to a dangerous level if this time period is exceeded. It has been proven that forearm submersion in a cooling agent is the best way to cool core body temperature for working fire fighters.

Previous attempts to facilitate forearm submersion include provision of a chair with a water basin at the armrest level. This however has the shortcoming that a supply of customised chairs which are cumbersome to transport and carry is required. This is a problem as there is usually not enough room in a fire truck to carry customised chairs. In fact, most tire tracks are stripped back to bare essentials only when used on long duration jobs so chairs would most likely not be available.

It is an object of the present invention to provide an apparatus which is capable of overcoming or ameliorating the above shortcoming or which will at least provide a useful alternative.

### SUMMARY OF THE INVENTION

According to the present invention there is provided an apparatus for reducing heat strain, the apparatus including;

at least one receptacle adapted to carry a coolant; and

a web attached to the receptacle;

wherein the web is adapted to engage and be suspended from a foreign object to support the receptacle.

In a preferred embodiment, the apparatus includes a pair of receptacles.

Preferably, the web is in the form of a strap having one end attached to one of the receptacles and an opposite end attached to the other receptacle. The strap is preferred to be adjustable in length by way of art adjusting means. The adjusting means is preferably a buckle.

The strap is preferred to include one or more slits. Preferably, the slits are spaced apart along the length of the strap. The step may include a holding means adapted to facilitate removable attachment of a wet towel to the strap.

It is preferred that the or each receptacle is cylindrical in shape. The or each receptacle may be in other shape or form suitable for carrying the coolant. The receptacle includes an enhanced band located towards its upper end and adapted to be connected to or form an integral part of the strap. Preferably, the receptacle also includes an enhanced bottom adapted to support the weight of the coolant. More preferably, the enhanced band and bottom are connected by an extension of the strap, the extension being adapted to strengthen the body of the receptacle. The enhanced bottom is preferred to be made of a high wear-resistant material The receptacle has a body which is preferred to include a porous wall so as to facilitate heat dissipation. The porous wall is preferably made of a plastic mesh. Even more preferably, the receptacle further includes an enhanced rim defining an opening.

Preferably, the or each receptacle is adapted to receive a disposable carrier which is configured to carry the coolant. The disposable carrier is preferably in the form of a plastic bag. In a preferred embodiment, the plastic bag is longer than the receptacle such that after insertion, an uppermost portion of the plastic bag may be folded over the enhanced rim of the receptacle. The plastic bag may include a marker to indicate the maximum capacity to avoid over-filling of water.

The foreign object may be the neck and shoulder of a human being or a chair.

When the foreign object is a human being, the strap is preferred to be hung around the neck and over the shoulders of the user. As such, the apparatus is firmly supported by the user whose forearms are free to be inserted into the pair of receptacles, respectively.

When the foreign object is a chair, two slits are preferred to be selected to engage two upper corners of the back of the chair, respectively. As such, each of the upper corners is received in the corresponding selected slit thereby securely interlocking the receptacle to the chair. As a consequence, the position of each receptacle is fixed with respect to the chair facilitating insertion of the forearms of a user who is sitting on the chair info the respective receptacles.

### BRIEF DESCRIPTION OF THE DRAWINGS

The invention may be belter understood from the following non-limiting description of a preferred embodiment, in which:

FIG. 1 is a perspective view of an apparatus in accordance with a preferred embodiment of the present invention;

FIG. 2 is a perspective view of the apparatus of FIG. 1 including a plastic bag for carrying water;

FIG. 3 is a perspective view of the apparatus of FIG. 1 being applied on a human body; and

FIG. 4 is a perspective view of the apparatus of FIG. 1 being mounted on a chair.

### DETAILED DESCRIPTION OF THE DRAWINGS

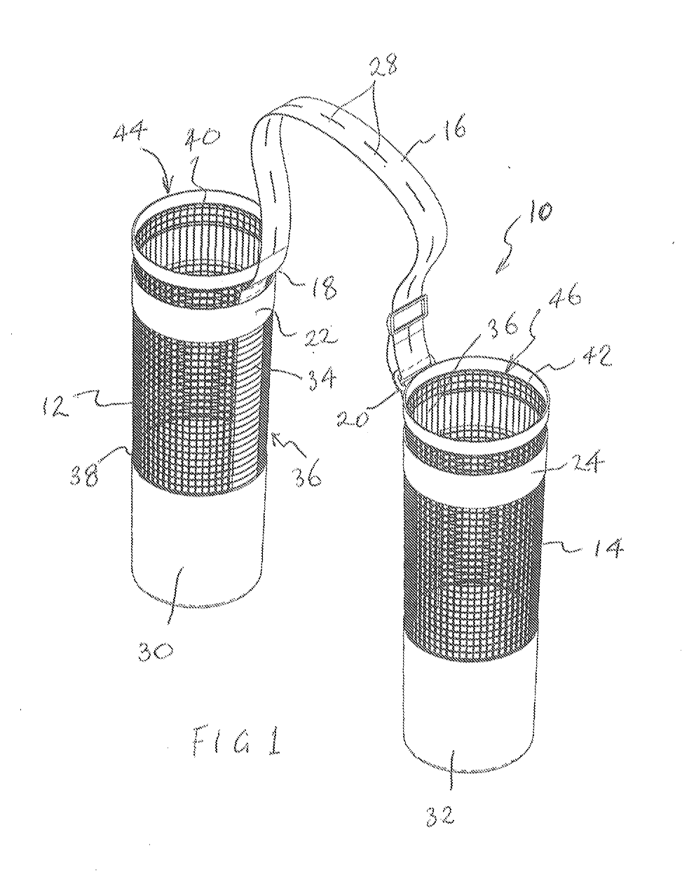

Referring to FIG. 1, an apparatus 10 for reducing heat strain is shown. The apparatus 10 has a pair of receptacles 12 & 14 and a web. Each receptacle 12, 14 is adapted to carry a coolant such as water.

As shown in FIG. 1, the web is in the form of a strap 16 having a portion 18 attached to an enhanced band 22 located towards an upper end of the receptacle 12, and another portion 20 attached to an enhanced band 24 of the receptacle 14. In the present embodiment, the enhanced band 22 is stitched onto the portion 18 of the strap 16. It should however be noted that the band 22 may form an integral part of the strap 16. The strap 16 is adjustable in length by way of an adjusting means in the form of a buckle 26. More than one buckle may be provided along the length of the strap 16 to provide flexibility. The strap 16 has a series of slits 28 which are spaced apart along the length of the strap 16.

As shown in FIG. 1, each receptacle 12, 14 is cylindrical in shape. Each receptacle 16 also includes an enhanced bottom 30, 32 which are configured to support the weight of the coolant (not shown). Taking receptacle 12 as an example, the enhanced band 22 and bottom 30 are connected by an extension 34 of the strap 16. The extension 34 is provided to strengthen the body 36 of the receptacle 12. The enhanced bottoms 30 & 32 are made of a high wear-resistant material such as Cordura™. The body 36 of, for example, receptacle 12 has a porous wall 38 so as to facilitate heat dissipation. The porous wall 38 is made of a plastic mesh. The enhanced bottom 30 serves the purpose of protecting the mesh from making direct contact with the ground and wearing out as a result. Each receptacle 12, 14 also has an enhanced rim 40, 42 defining an opening 44, 46.

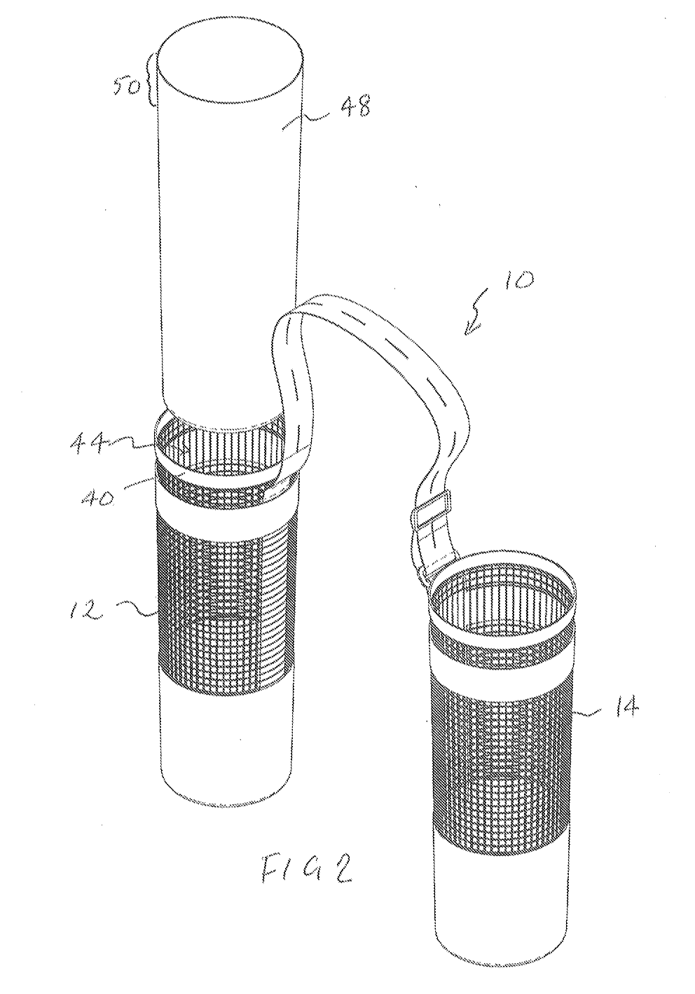

Turning to FIG. 2, as an example, receptacle 12 is configured to receive a disposable carrier in the form of a plastic bag 48 which in turn carries the coolant. Although not shown in FIG. 2, an identical plastic bag (not shown) is provided for receptacle 14. The plastic bags 48 are disposable and applied for hygiene reasons. The plastic bag 48 is designed to be longer than the receptacle 12 such that alter insertion, an uppermost portion 50 of the plastic bag 48 may be folded over the enhanced rim 40 of the receptacle 16 so as to secure the position of the plastic bag 48. Although not shown in the accompanying drawings, the plastic bag may contain a marker to indicate its maximum capacity so as to avoid over-filling of water which will result in an overflow after insertion of the forearms.

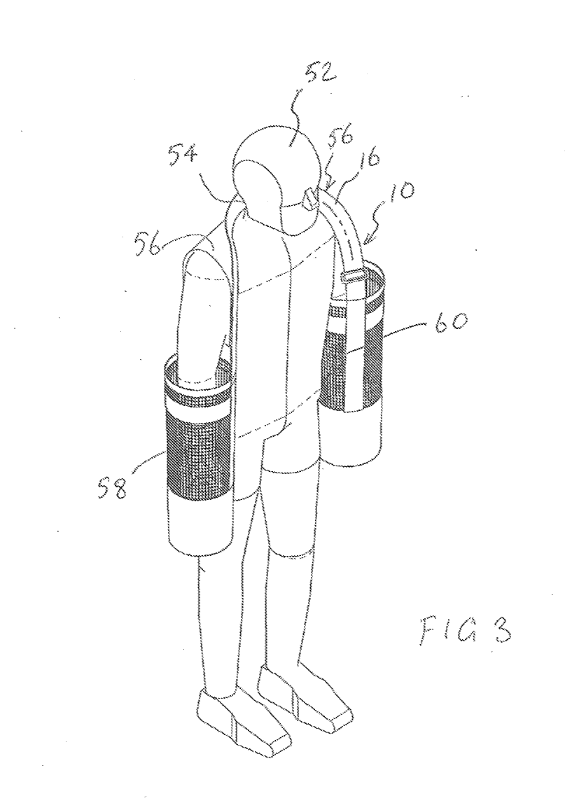

Turning to FIG. 3, wherein the web is adapted to engage and be suspended from a foreign object to support the receptacle.

It should be noted that the foreign object may be the neck and shoulder of a human being or a chair.

Referring to FIG. 3, when the foreign object is a human being, the strap 16 is hung around the neck 54 and over the shoulders 56 of the user 52. As such, the apparatus 10 is firmly supported by the user 52 whose forearms 58 & 60 are free to be inserted into the pair of receptacles 12 & 14, respectively. It will be appreciated that the apparatus 10 may be utilised by a fire fighter while resting under just about any circumstances. For instance, once equipped with the apparatus, the fire fighter can sit up against a wall, a tree log, a tree stump, against a fire truck tyre or on a bench etc. and have the receptacles, which are receiving the forearms, resting on the ground.

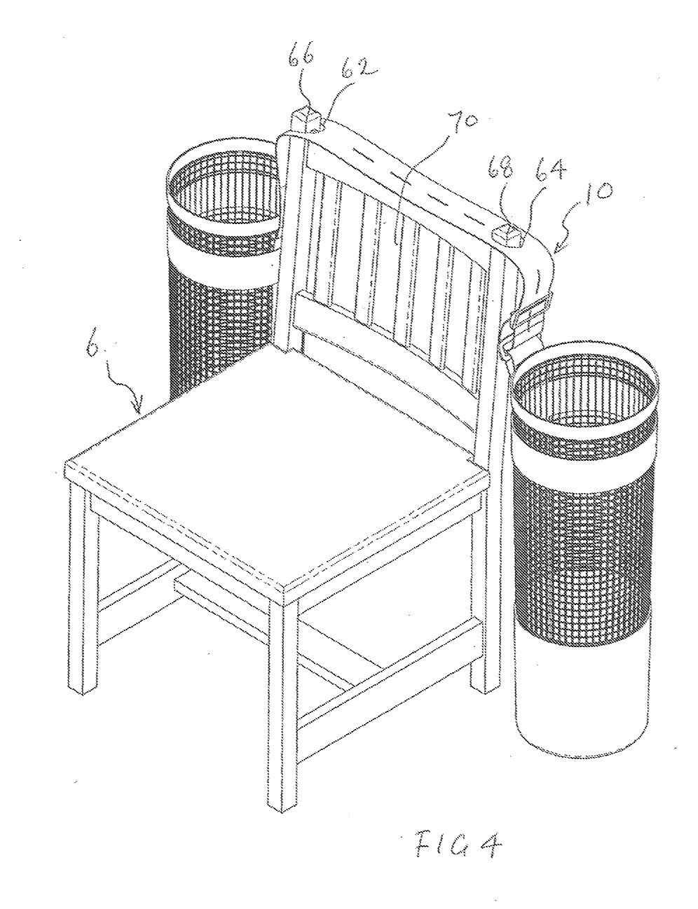

Referring to FIG. 4, when the foreign object is a chair 61, two slits 62 & 64 are selected to engage two upper corners 66 & 68 of the back 70 of the chair 61, respectively. As such, each of the upper corners 66, 68 is received in the corresponding selected slit 62, 64 thereby securely interlocking the receptacle 10 to the chair 61. As a consequence, the position of each receptacle 12, 14 is fixed with respect to the chair 61 facilitating insertion of the forearms 58, 60 of a user (not shown) who is sitting on the chair 61 into the respective receptacles 12 & 14. Note that the plastic bags 48 are omitted in FIG. 4 in order to facilitate clear illustration of the placement of the forearms 58 & 60. It will be appreciated that the apparatus of the present invention is suitable for mounting onto most chairs with a back including camping chairs and plastic moulded chairs. It will be appreciated that the apparatus of the present invention may be mounted on different designs of chairs. This is significantly advantageous as some fire trucks do have some sort of chairs and many staging areas do have chairs of different descriptions, most of which the apparatus 10 will fit. For long duration jobs, it is commonplace to have a staging area set up at for example a sports field or stadium where a large number of fire trucks can be parked and where a large number of fire fighters can rest between operations. Typically, a large number of different chairs are randomly brought out from the club or a local community centre. It is therefore advantageous that the apparatus 10 can be applied to chairs of different designs and configurations.

It is contemplated that the apparatus of the present invention may be manufactured in a size which would fit into the pocket of a fire fighter uniform. It is also contemplated that the strap includes a holding means adapted to facilitate removable attachment of a cooling means such as a wet towel to the strap. As such, a towel can be soaked in cool water and then wrapped around the neck of the user in order to generate an outstanding cooling effect.

Now that a preferred embodiment of the present invention has been described in some detail it will be apparent to a skilled person in the art that the apparatus of the present invention may offer at least the following advantages:
1. it is easy to carry and use;
2. it is highly versatile being able to be used with or without a chair thereby significantly reducing the fire fighters waiting time;
3. it is adaptive being able to be mounted on chairs in different sizes, designs and configurations; and
4. it is re-usable by different fire fighters only requiring a change of the plastic bag;

Those skilled in the art will appreciate that the invention described herein is susceptible to variations and modifications other than those specifically described. All such variations and modifications are to be considered within the scope and spirit of the present invention the nature of which is to be determined from the foregoing description.

1. An apparatus for reducing heat strain, the apparatus including;
at least one receptacle adapted to carry a coolant; and
a web attached to the receptacle;
wherein the web is adapted to engage and be suspended from a foreign object to support the receptacle.

2. The apparatus of claim 1, which includes a pair of receptacles.

3. The apparatus of claim 1, wherein the web is in the form of a strap having one end attached to one of the receptacles and an opposite end attached to tire other receptacle.

4. The apparatus of claim 3, wherein the strap is adjustable in length by way of an adjusting means.

5. The apparatus of claim 4, wherein the adjusting means is a buckle.

6. The apparatus of claim 3, wherein the strap includes one or more slits spaced apart along the length of the strap.

7. The apparatus of claim 3, wherein the strap includes a holding means adapted to facilitate removable attachment of a cooling means to the strap.

8. The apparatus of claim 1, wherein the or each receptacle is cylindrical in shape.

9. The apparatus of claim 1, wherein the receptacle includes an enhanced band located towards its upper end and adapted to be connected to or form an integral part of the strap.

10. The apparatus of claim 1, wherein the receptacle also includes an enhanced bottom adapted to support the weight of the coolant.

11. The apparatus of claim 10, wherein the enhanced band and bottom are connected by an extension of the strap, the extension being adapted to strengthen the body of the receptacle.

12. The apparatus of claim 10, wherein the enhanced bottom is made of a high wear-resistant material.

13. The apparatus of claim 1, wherein the receptacle has a body which includes a porous wall so as to facilitate heat dissipation.

14. The apparatus of claim 13, wherein the porous wall is made of a plastic mesh.

15. The apparatus of claim 1, wherein the receptacle further includes an enhanced rim defining an opening.

16. The apparatus of claim 1, wherein the or each receptacle is adapted to receive a disposable carrier which is configured to carry the coolant.

17. The apparatus of claim 16, wherein the disposable carrier is in the form of a plastic bag.

18. The apparatus of claim 17, wherein the plastic bag is longer than the receptacle rendering an uppermost portion of the plastic bag foldable over the enhanced rim of the receptacle.

19. The apparatus of claim 17, wherein the plastic bag includes a marker to indicate the maximum capacity to avoid over-filling of water.

20. The apparatus of claim 1, wherein the foreign object is the neck and shoulder of a human being or a chair.

21. The apparatus of claim 20, wherein the strap is hung around the neck and over the shoulders of the user.

22 The apparatus of claim 6, wherein when the foreign object is a chair, two of the slits are selected to engage two upper corners of the back of the chair, respectively.

23. The apparatus of claim 22, wherein each of the upper corners is received in the corresponding selected slit thereby securely interlocking the receptacle to the chair.
